(19) United States
(12) Patent Application Publication
(10) Pub. No.: US 2011/0178937 A1
(43) Pub. Date: Jul. 21, 2011

(54) Systems and Methods for Detecting Unexpected Utility Usage

(76) Inventor: Jonathan Bud Bowman, Scottsdale, AZ (US)

(21) Appl. No.: 12/687,878

(22) Filed: Jan. 15, 2010

(51) Int. Cl. G06Q 50/00; G06Q 10/00; G06F 17/30

(52) U.S. Cl. 705/314; 705/412; 707/758; 707/E17.014

(57) ABSTRACT

A utility management system associated with at least one multiple unit residential facility comprises an onsite metering system configured to monitor at least one metering sensor. A property management system is configured to communicate occupancy data for at least one residential unit. A utility management server comprises a usage database capable of receiving usage data from the onsite metering system, along with an occupancy database capable of receiving occupancy data from the property management system. The utility management server also includes usage analysis software configured to compare the usage data with the occupancy data for at least one residential unit to determine whether one or more exceptions exist. A notice generation system is configured to receive exception data from the utility usage analysis system. The notice generation system is capable of running notice generation software configured to generate a notice when an exception has been identified in the exception data.

### BACKGROUND

1. Technical Field

Aspects of the present document relate generally to systems and methods for detecting unexpected utility usage and more specifically to systems and methods for detecting unexpected utility usage in one or more unoccupied and/or occupied residential units in one or more multiple unit residential facilities.

2. Background Art

Preventing unexpected utility usage in structures having a large number of utility fixtures such as apartments, condominiums, and other multiple unit residential facilities may have dramatic economic and environmental benefits for property owners, managers, landlords and tenants.

### SUMMARY

Aspects of this document relate to systems and methods for detecting unexpected utility usage in one or more unoccupied and/or occupied residential units in one or more multiple unit residential facilities.

In one aspect, a utility management system associated with at least one multiple unit residential facility comprises at least one onsite metering system configured to monitor at least one metering sensor. At least one property management system is configured to communicate occupancy data for at least one residential unit and at least one utility management server is in communication with the at least one onsite metering system and the at least one property management system. The at least one utility management server comprises at least one usage database capable of receiving usage data from the at least one onsite metering system and at least one occupancy database capable of receiving occupancy data from the at least one property management system, along with at least one utility usage analysis system having usage analysis hardware capable of running usage analysis software configured to compare the usage data with the occupancy data for at least one residential unit to determine whether one or more exceptions exist. At least one notice generation system is configured to receive exception data from the at least one utility usage analysis system. The at least one notice generation system includes notice generation hardware capable of running notice generation software configured to generate at least one notice when one or more exceptions have been identified in the exception data.

Particular implementations may include one or more of the following. One of the following occurs continuously, periodically and on-demand: the at least one onsite metering system is configured to monitor the at least one metering sensor; the at least one property management system is configured to communicate occupancy data; the at least one utility management server is capable of receiving the usage data from the at least one metering server and occupancy data from the at least one property management system; the usage analysis software is configured to compare the usage data with the occupancy data; and the notice generation software is configured to compare the exception data to one or more notice preferences.

Particular implementations may further include one or more of the following. At least one exception may be determined based on a lockstep comparison of the usage data to the occupancy data for at least one residential unit. The at least one utility usage analysis system may further comprise at least one usage threshold database capable of storing at least one default usage threshold. The usage threshold database may be capable of receiving and storing at least one user-defined usage threshold communicated via at least one user interface. The usage analysis software may be configured to determine that at least one exception exists when the occupancy data indicates that at least one residential unit is unoccupied and the usage data for the at least one residential unit one of meets and exceeds at least one usage threshold. The usage analysis software may be configured to determine that at least one exceptions exist when the occupancy data indicates that at least one residential unit is occupied and the usage data for the at least one residential unit one of meets and exceeds at least one usage threshold. The usage analysis software may be configured to determine that at least one exception exists when the occupancy data indicates that at least one residential unit is occupied and the usage data for the at least one residential unit one of meets and falls below at least one usage threshold. The utility usage analysis system may further comprise at least one exception database configured to receive exception data from the usage analysis software. The at least one notice generation system may be capable of receiving the exception data from the at least one exception database. The at least one notice generation system may further comprise at least one notice preference database capable of storing at least one default notice preference. The notice preference database may be capable of receiving and storing at least one user defined notice preference communicated via at least one user interface. The notice generation software may be configured to compare the exception data to at least one notice preference and generate at least one notice when at least one notice preference has been satisfied by the exception data. The notice generation software may be configured to generate at least one notice when no exceptions are identified in the exception data by the notice generation software.

In another aspect, A method of identifying unexpected usage of a utility comprises receiving usage data in at least one onsite metering system from at least one metering sensor and communicating the usage data from the at least one onsite metering system to at least one usage database. The usage data is received in the at least one usage database and occupancy data is communicated from at least one property management system to at least one occupancy database. The method further includes receiving the occupancy data in the at least one occupancy database and comparing the usage data with the occupancy data for at least one residential unit. Determining whether one or more exceptions has occurred is based on comparing the usage data to the occupancy data for the at least one residential unit. Generating one or more notices occurs when one or more exceptions have been identified.

Particular implementations may include one or more of the following. At least one of the following may occur one of continuously, periodically and on-demand: receiving usage data in at least one onsite metering system; communicating the usage data from the at least one onsite metering system to at least one usage database; communicating occupancy data from at least one property management system to at least one occupancy database; comparing the usage data with the occupancy data for at least one residential unit; determining whether one or more exceptions have occurred; and generating one or more notices when one or more exceptions have been identified.

Particular implementations may include one or more of the following. Determining whether one or more exceptions has occurred may further comprise comparing lockstep the usage data to the occupancy data for at least one residential unit. Usage data may be compared with at least one usage threshold for the at least one residential unit. Determining that one or more exceptions exist may comprise determining that the occupancy data for the at least one residential unit indicates that the at least one residential unit is unoccupied and the usage data for the at least one residential unit one of meets and exceeds at least one usage threshold. Determining that one or more exceptions exist may comprise determining that the occupancy data for the at least one residential unit indicates that the at least one residential unit is occupied and the usage data for the at least one residential unit one of meets and exceeds at least one usage threshold. Determining that one or more exceptions exist may comprise determining that the occupancy data for the at least one residential unit indicates that the at least one residential unit is occupied, and the usage data for the at least one residential unit one of meets and falls below at least one usage threshold. Exception data for the at least one residential unit may be received in at least one notice generation system. The method may further include comparing the exception data for the at least one residential unit to at least one notice preference and generating at least one notice when at least one notice preference has been satisfied by the exception data for the at least one residential unit. The method may further include generating at least one notice when no exceptions have been determined.

The foregoing and other aspects, features, and advantages will be apparent to those having ordinary skill in the art from the DESCRIPTION and DRAWINGS, and from the CLAIMS.

### BRIEF DESCRIPTION OF THE DRAWINGS

Various particular implementations of systems and methods for detecting unexpected utility usage will hereinafter be described in conjunction with the appended drawings, where like designations denote like elements, and:

FIG. 1 illustrates a block diagram of first particular implementation of a utility management system;

FIG. 2 illustrates a block diagram of a first particular implementation of an onsite metering system for use in connection with a utility management system;

FIG. 3 illustrates a block diagram of a first particular implementation of a utility usage analysis system for use in connection with a utility management system;

FIG. 4 illustrates a block diagram of a first particular implementation of a notice generation system for use in connection with a utility management system;

FIG. 5 illustrates a first particular implementation of a hardware and software based method for identifying unexpected utility usage;

FIG. 6 illustrates an additional particular implementation of a hardware and software based method based method for identifying unexpected utility usage; and

FIG. 7 illustrates a further particular implementation of a hardware and software based method for identifying unexpected utility usage.

### DESCRIPTION

This disclosure, its aspects and implementations, are not limited to the specific systems, components, software and/or methods of operation disclosed herein. Many additional systems, components, software and/or methods of operation consistent with the intended operation of a system and/or a method for detecting unexpected utility usage will become apparent from this disclosure. Accordingly, for example, although particular utility management systems, property management systems, user interfaces, onsite metering systems, metering sensors, metering databases, utility management servers, usage databases, occupancy databases, utility usage analysis systems, utility usage analysis system comparison hardware, utility usage analysis system comparison software, usage threshold databases, exception databases, notice generation systems, notice generation system comparison hardware, notice generation system comparison software, notice preference databases, communication systems, hardware, devices, and other components and/or features are disclosed, such particular utility management systems, property management systems, user interfaces, onsite metering systems, metering sensors, metering databases, utility management servers, usage databases, occupancy databases, utility usage analysis systems, utility usage analysis system comparison hardware, utility usage analysis system comparison software, usage threshold databases, exception databases, notice generation systems, notice generation system comparison hardware, notice generation system comparison software, notice preference databases, communication systems, hardware, devices, and implementing components, may comprise any style, type, configuration, model, version and/or the like of any hardware and/or software that is known in the art for such systems and/or methods of detecting unexpected utility usage, consistent with the intended operation of a system and/or method for detecting unexpected utility usage.

There are a variety of particular implementations of systems and methods for detecting unexpected utility usage disclosed herein. As used herein the term “unexpected utility usage” refers at least to unexpected and/or unusual utility usage in one or more unoccupied and/or occupied residential units in one or more multiple unit residential facilities. As described further, unexpected utility usage may be determined by determining whether one or more exceptions exist based at least upon comparing usage data to occupancy data and/or comparing usage data to one or more “usage thresholds” for one or more residential units. As described further herein, one or more “usage thresholds” may be established by one or more users to assist in setting one or more expectations with respect to utility use for one or more residential units (whether vacant or occupied). In addition, one or more usage thresholds may be established by default such as, by way of non-limiting example, via one or more pre-established settings.

Therefore, as set forth further herein, “unexpected utility usage” may be determined at least when one or more “exceptions” have been determined between usage data and occupancy data (and/or as compared to one or more usage thresholds) for one or more residential units. Exceptions, as described further herein, may therefore include, among other things, those instances where usage data for one or more residential units meets and/or exceeds one or more usage thresholds and/or where usage data for one or more residential units meets and/or falls below one or more usage thresholds. Accordingly, as used herein, “unexpected utility usage” may variously comprise at least: unexpectedly high vacant unit utility usage; unexpectedly high occupied unit utility usage; and/or unexpectedly low occupied unit utility usage.

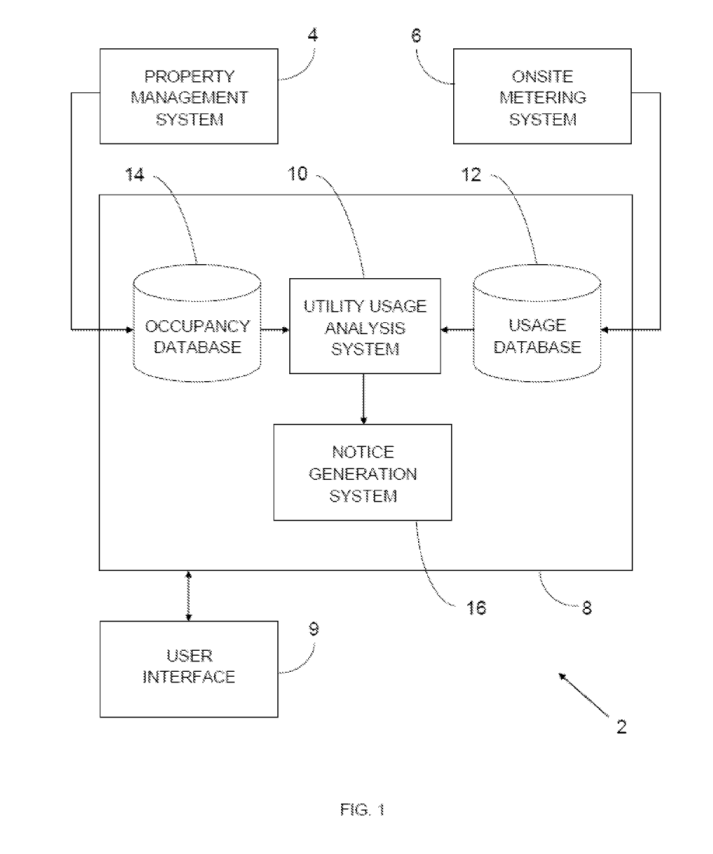

FIGS. 1-7 illustrate various aspects and features of the particular implementations of systems and/or methods for detecting unexpected utility usage disclosed herein. Referring to FIG. 1, a first particular implementation of a utility management system 2 is illustrated. As described further, one or more utility management systems 2 can be configured to manage utility usage in one or more multiple unit residential facilities such as, by way of non-limiting example, apartment buildings, condominiums, trailer parks, dormitories, multi-family homes, and/or the like. One or more utility management systems 2 can further be configured to determine whether one or more “exceptions” has occurred relating to unexpected utility usage in one or more residential units. One or more utility management systems 2 can yet further be configured to generate one or more notices to one or more users when one or more exceptions have been detected with respect to one or more residential units.

By assisting users in proactively identifying when one or more unoccupied and/or occupied residential units are using an unexpected amount of utilities, users may help affirmatively identify unexpected utility usage. Accordingly, users may be able to avoid large utility bills and/or derive other benefits as a result of proactively identifying unexpected utility usage. The term “users” as used herein is intended to encompass at least property owners, landlords, property management companies and personnel, maintenance companies and personnel, individual tenants, third party entities, and any other individual or organization using the systems, methods, components and/or software described herein. Third party entity users may include one or more third party billing systems and/or one or more property management systems such as, by way of non-limiting example, Yardi^{SM}, Realpage^{SM}, MRI^{SM}, AMSI^{SM} and/or the like. It will be appreciated that the timely identification of unexpected utility use in one or more residential units (whether unoccupied or occupied) may be particularly desirable and cost-beneficial for users responsible for payment of the utility bills for those residential units.

As illustrated by FIG. 1, one or more utility management systems 2 may include one or more property management systems 4 which may be in communication continuously, periodically, and/or on-demand with one or more utility management servers 8. As used herein, the term “on-demand” may refer variously to: upon the demand of one or more users; and/or upon demand of one or more systems, servers, devices, communications, hardware, databases, components and/or other features described herein. Therefore, it will be understood that one or more systems, servers, devices, communications, hardware, databases, components and/or features described herein may be variously configurable to send, receive, communicate, update, compare, determine, identify, generate, notify and/or perform the various other functions described herein upon the demand (e.g. on-demand) of one or more users and/or one or more systems, servers, devices, communications, hardware, databases and/or other components described herein.

One or more property management systems 4 may include one or more personal or business computer systems containing one or more memories and one or more user interfaces 9. Depending upon the particular implementation, one or more property management systems 4 may be used to communicate data (such as, by way of non-limiting example, occupancy data), to one or more utility management servers 8. It will be understood that one or more property management systems 4 may include one or more third party entity systems such as, by way of non-limiting example, those implemented by Yardi^{SM}, Realpage^{SM}, MRI^{SM}, AMSI^{SM}, and/or the like. Accordingly, in some particular implementations, occupancy data and/or other data may be communicated via one or more property management systems 4 from one or more third party entities and/or users.

As described further below, a variety of user interfaces 9 may be provided to enable one or more users to perform a variety of functions such as, by way of non-limiting example, communicate occupancy data for one or more residential units and/or tenants to one or more occupancy databases 14. In some particular implementations, one or more user interfaces 9 (which may stand-alone and or be associated with any system, server, database, hardware, component and/or device disclosed herein) may be provided in order to enable one or more users to set and/or change one or more thresholds, such as one or more “usage thresholds,” described further below. In other particular implementations, one or more user interfaces 9 may be provided to enable one or more users to set and/or change one or more preferences, such as one or more “notice preferences,” described further below. In still other particular implementations, one or more user interfaces 9 may be provided to enable one or more users to communicate information such as, by way of non-limiting example, historical usage data for one or more residential units and/or tenants to one or more databases.

In still other particular implementations, one or more user interfaces 9 may be provided to enable one or more users to issue one or more repair requests and/or initiate any other function that may be initiated via one or more user interfaces. In addition, one or more user interfaces may be provided to enable one or more users to configure any system, server, database, software, and/or other configuration consistent with the disclosures contained herein.

It will be understood that the various user interfaces described herein may include any direct, indirect, web-based, and/or any other user interface known in the art configurable to enable one or more users to initiate, configure, and/or stop one or more computer functions. By way of non-limiting example, one or more user interfaces may include one or more graphical user interfaces, command line interfaces, tactile interfaces, gesture interfaces, touch user interfaces, attentive user interfaces, batch interfaces, conversational interfaces, non-command user interfaces, object-oriented user interfaces, task-focused interfaces, telephonic interfaces, text user interfaces, voice user interfaces, zero-input interfaces, and/or any other user interface known in the art and consistent with these disclosures.

One or more property management systems 4 (and/or one or more of the other systems, servers, hardware, software, databases and/or other components disclosed herein) may further include appropriate communications hardware and/or software capable of communicating and receiving information (such as, by way of non-limiting example, occupancy data for one or more residential units) via one or more computer hardware devices, telephonic devices, and/or computer networks. Some particular implementations of property management systems (and/or one or more of the other systems, servers, hardware, software, databases and/or other components disclosed herein) may include one or more cellular telephones, portable computers, cellular pagers, PDA's and/or any other electronic device capable of communicating and/or receiving information with one or more telephonic devices, computer hardware devices and/or computer networks.

It is specifically contemplated that additional computers and/or operating systems could additionally be implemented, such as, for example, Mac's and/or PC's running Linux-based software and/or operating systems, Apple-based software and/or operating systems, and/or other Windows-based and/or other operating systems. In addition to the foregoing, it will be understood that appropriate communications devices, connections, and/or software may be provided between the various components included in the various particular implementations one or more utility management systems disclosed herein.

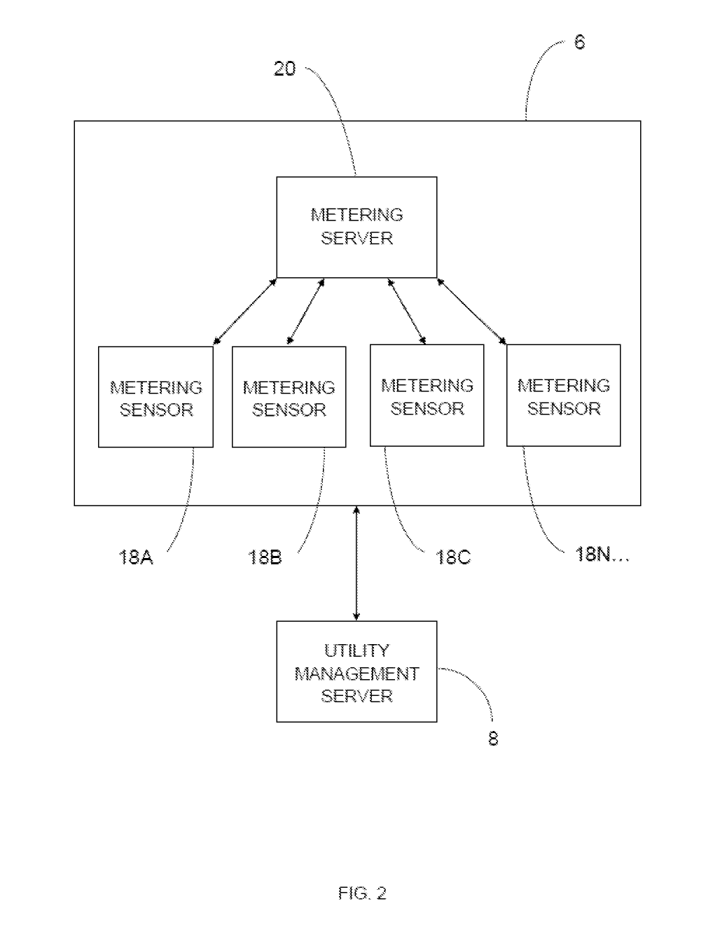

Turning now to FIG. 2, this figure illustrates a detail view of a first particular implementation of an onsite metering system 6 illustrated by FIG. 1. One or more onsite metering systems 6 may be associated with one or more multiple unit residential facilities and may include one or more metering sensors (such as one or more metering sensors 18a-18n) in communication with one or more metering servers 20. It will be understood that one or more components defining one or more onsite metering systems 6 may be located on-site at one or more residential units and/or multiple unit residential facilities. Alternatively, one or more components defining one or more onsite metering systems 6 may be located remotely off-site from one or more units/facilities. For example, in some particular implementations, one or more metering servers 20 included in one or more onsite metering systems 6 may be located off-site from one or more multiple unit residential facilities.

One or more metering sensors 18a-18n may comprise any metering sensor known in the art configurable to measure, meter, monitor, record, track, and/or collect “usage data” for one or more residential units. As used herein “usage data” may include raw and/or processed “metering sensor data” received by one or more metering sensors and/or may include raw and/or processed “utility consumption data” relating at least to an amount of a utility used by (and/or provided to) one or more residential units. It will be further understood that, in some particular implementations, “usage data” may further include data relating to, among other things, one or more addresses of one or more residential units, one or more identities of one or more tenants, and/or other data.

By way of non-limiting example, one or more metering sensors 18a-18n may be compatible for use with one or more proprietary and/or commercially available submetering systems such as, by way of non-limiting example, Inovonics' “TapWatch” system. One or more metering sensors 18a-18n may alternatively include any utility meter and/or sensor known in the art, such as those including one or more highly-sensitive wireless flow sensor nodes that may be configurable to monitor utility usage continuously, periodically and/or on-demand.

In any event, one or more metering sensors 18a-18n may be installed on-line or in-line with one or more utility supply lines (which may supply a particular utility from one or more utility provider systems, not shown). Depending upon specific supply and billing arrangements, a particular supply line may supply a utility to one or more individual residential units, one or more groups of residential units, one or more buildings of residential units, and/or even one or more complexes of residential unit buildings. It will be appreciated that the systems and methods described herein may be applied to many situations involving multiple unit residential facilities, including many different utility supply and/or billing arrangements.

In some particular implementations, one or more metering sensors 18a-18n may be programmed to continuously, periodically and/or on-demand detect “use” and/or “no use” conditions. Accordingly, one or more utility services being supplied via one or more utility supply lines to one or more residential units and/or facilities may be monitored continuously, periodically, and/or as-desired by one or more users.

“Usage data” may be collected by one or more metering sensors 18a-18n and may be stored in one or more sensor nodes (which may be included in or attached to each of the one or more metering sensors 18a-18n) for transmission as one or more streams of data points and/or one or more data packets. Likewise, one or more streams of data points and/or one or more data packets collected from one or more metering sensors 18a-18n may be transmitted to one or more metering servers 20 continuously, periodically, and/or on-demand.

Usage data (and other data described herein) may be communicated from the one or more metering sensors 18a-18n to the one or more metering servers 20 via one or more radio frequency (rf) networks and/or one or more other appropriate communication networks including via a modem, over the internet, via satellite, via email, FTP, and/or any other communications network. It will be understood that one or more metering sensors 18a-18n may be operated in a low-power mode such as, by way of non-limiting example, only to transmit at random and/or pre-determined times of the day. In any event, usage data may be continuously, periodically and/or on-demand received in one or more metering servers 20 that, depending upon the particular implementation, may be configured to receive, collect, store, and/or analyze “usage data” from the one or more sensors 18a-18n, consistent with these disclosures.

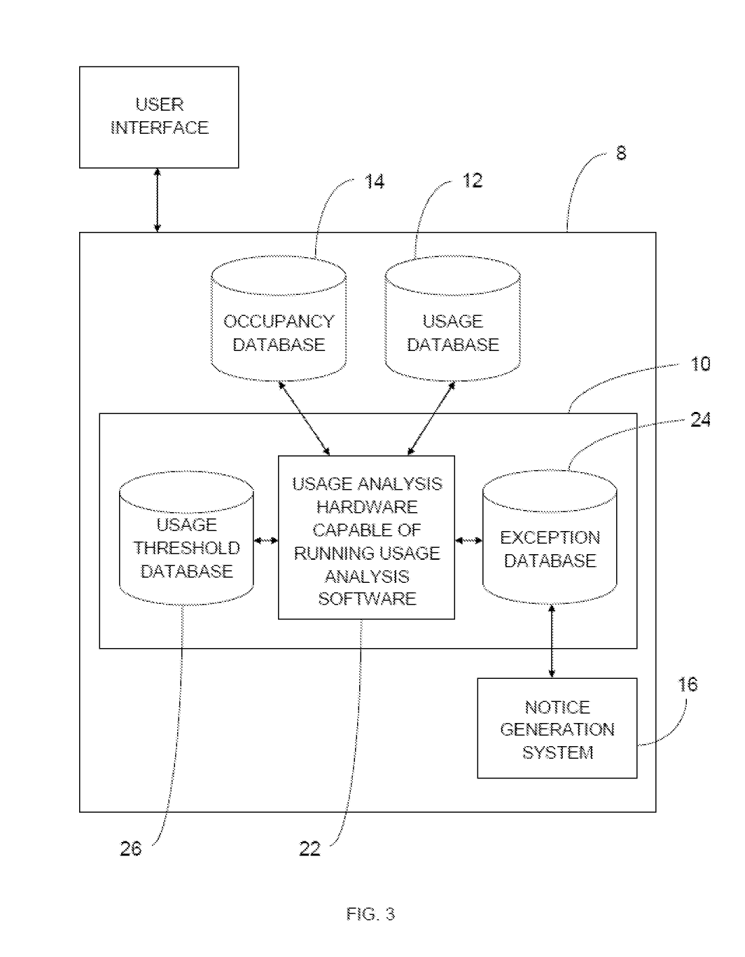

“Usage data” and/or other data described herein can be communicated (continuously, periodically and/or on-demand) from one or more onsite metering systems 6 to one or more utility management servers 8 and/or other systems, servers and/or databases. As will be described in detail with respect to FIG. 3, “usage data” (and/or any other data described herein) may be communicated, received, collected, stored, compared, analyzed and/or otherwise processed and/or stored in one or more raw and/or processed data formats.

Turning now to FIG. 3, a detail view of a first particular implementation of a utility management server is illustrated. Depending upon the particular implementation, one or more utility management servers 8 may include one or more utility usage analysis systems 10, one or more usage databases 12, one or more occupancy databases 14, and/or one or more notice generation systems 16. It will be understood, however, that other particular implementations of one or more utility management servers may include additional features and/or components according to the needs of one or more users and/or the demands of a particular application.

One or more usage databases 12 may be in communication with one or more onsite metering systems 6 (and/or with one or more metering servers 20). The one or more usage databases 12 may be configured to continuously, periodically and/or on-demand receive and/or store utility usage data from one or more onsite metering systems 6 and/or one or more metering servers 20.

One or more occupancy databases 14 are configurable to receive “occupancy data” which may include, among other data types, data related to whether one or more units is “occupied” (e.g. tenant-occupied) or “unoccupied” (e.g. vacant). In some particular implementations, occupancy data may further include data relating to, among other things, one or more addresses of one or more residential units, one or more identities of one or more tenants, and/or other data. Occupancy data may be provided continuously, periodically and/or on-demand to one or more occupancy databases 14 from one or more property management systems (which may include one or more third party entities and/or billing systems).

It will be noted that one or more utility usage analysis systems 10 may be in communication with one or more usage databases 12 and/or one or more occupancy databases 14. The one or more utility usage analysis systems 10 may be configured to receive at least usage data and occupancy data communicated from one or more usage databases 12 and one or more occupancy databases 14, respectively (and/or from other data sources, depending upon the particular implementation). In some particular implementations, one or more utility usage analysis systems 10 may include usage analysis hardware 22 capable of running, among other software, utility usage analysis system comparison software, or “usage analysis software,” configurable at least to compare usage data with occupancy data for one or more residential units in order to determine whether one or more “exceptions” exist between the usage data and the occupancy data for one or more residential units.

Depending upon the particular implementation, determining whether one or more exceptions (and/or no-exception conditions) exist may be based upon a “lockstep” comparison between usage data and occupancy data for one or more residential units. By way of non-limiting example, when configured for lockstep comparison, the usage analysis software may be configurable at least to determine that an exception has occurred where a comparison of usage data to occupancy data for one or more unoccupied units indicates any utility usage whatsoever.

Likewise, when configured for lockstep comparison, and by way of further non-limiting example, the usage analysis software may be configurable at least to determine that no exceptions exist where the usage data for one or more unoccupied units indicates zero usage. Conversely, under a lockstep comparison approach, and by way of yet further non-limiting example, the usage analysis software may be configurable at least to determine that an exception has occurred where a comparison of usage data to occupancy data for one or more occupied units indicates no utility usage.

In addition to the foregoing lockstep comparisons, it will be understood that the usage analysis software may be further configurable to perform additional and/or alternative comparisons of and/or between usage data and/or occupancy data (and/or other data) for one or more residential units. Specifically, as described further below, the usage analysis software may be configurable to at least compare usage data and/or occupancy data for one or more residential units with one or more “usage thresholds.”

“Usage thresholds” may be set and/or determined by one or more equipment manufacturers and/or software providers (e.g. “default” thresholds), and/or by one or more users (e.g. “user-defined” thresholds), such as via one or more user interfaces. In some particular implementations, one or more usage thresholds may be based upon, by way of non-limiting example, historical usage patterns for one or more residential units and/or tenants, one or more general default settings, and/or based upon one or more additional factors.

In addition to the foregoing, one or more usage thresholds may be established according to the needs of one or more users and/or the demands of one or more applications. One or more usage thresholds may be received and/or stored in one or more usage threshold databases 26, which may be accessed at least by the usage analysis software (and/or one or more user interfaces). As described further below, one or more usage thresholds may be established at least to set parameters by which the usage analysis software may use to compare usage data and/or other data against when determining whether one or more exceptions exist in one or more unoccupied or occupied residential units.

In those instances where one or more users desire to detect unexpected utility usage in one or more unoccupied residential units (e.g. units that occupancy data indicates are unoccupied) where little or no utility usage might be expected, one or more usage thresholds may be set by a user at or near zero (e.g., at or near 0 units of utilities used). In such instances, if more than the threshold amount of utilities are used (e.g. unexpected vacant unit utility usage), the usage analysis software may determine one or more exceptions, since the usage data meets or exceeds one or more usage thresholds. In those instances where one or more users desire to detect unexpected utility usage in one or more unoccupied residential units where some utility usage is desired and/or expected, one or more usage thresholds may be set higher than at or near zero such that one or more exceptions may not be determined by the usage analysis software until the usage data meets and/or exceeds one or more usage thresholds.

The usage analysis software may be configurable to detect one or more exceptions when occupancy data for one or more residential units indicates that the one or more units are unoccupied, yet the usage data for the one or more units meets and/or exceeds one or more usage thresholds. Detecting unexpectedly high vacant unit utility usage in one or more unoccupied residential units may be particularly helpful in identifying leaks, running appliances and/or fixtures, and/or other unexpected repair conditions in such units.

In addition to the foregoing, one or more usage thresholds may likewise be set for one or more occupied residential units (e.g. units that occupancy data indicates are occupied by one or more tenants). It will be understood that one or more usage thresholds (and/or notification preferences) may be simultaneously, concurrently, automatically and/or by default set for two or more occupied and/or unoccupied units. By way of non-limiting example, in some particular implementations, one or more usage thresholds (and/or notification preferences) may be simultaneously concurrently, automatically and/or by default set for all or some occupied units, all or some unoccupied units, and/or for all or some units for which one or more usage thresholds (and/or notification preferences) are desired to be established.

The usage analysis software may be configured at least such that one or more exceptions may be determined if usage data for one or more occupied units satisfies one or more usage thresholds (e.g. unexpectedly high occupied unit utility usage). Alternatively, the usage analysis software may be configurable at least such that one or more exceptions may be detected if usage data for one or more occupied units meets and/or falls below one or more usage thresholds (e.g. unexpectedly low occupied unit utility usage).

It will be therefore understood that the usage analysis software may be configured at least to detect one or more exceptions when occupancy data for one or more residential units indicates that the one or more units are occupied, yet the usage data for the one or more units satisfies and/or falls below one or more usage thresholds. Detecting unexpectedly high occupied unit utility usage in one or more occupied residential units may be particularly helpful in identifying leaks, running appliances and/or fixtures, and/or other unexpected utility repair conditions in such units. Likewise, detecting unexpectedly low occupied unit utility usage in one or more occupied residential units may be particularly helpful in identifying faulty or bypassed meters, utility theft, and/or additional unexpected utility repair conditions.

By allowing users to establish various usage thresholds according to their needs, users may be able to detect one or more exceptions identifying unexpected utility usage in one or more occupied and/or unoccupied residential units, whether some or no utility use is expected.

In some particular implementations, usage analysis software may be configured to run continuously, periodically, and/or on-demand in order to proactively identify one or more exceptions. When the usage analysis software has identified one or more exceptions with respect to one or more residential units, the software may store data relating to such exceptions, or even non-exceptions (collectively “exception data”) in one or more exception databases 24. As used herein “exception data” may include raw and/or processed data (such as an amount of utility used and/or other data) relating to one or more exceptions for one or more residential units. It will be further understood that, in some particular implementations, exception data may further include data relating to, among other things, one or more addresses of one or more residential units, one or more identities of one or more tenants, and/or other data.

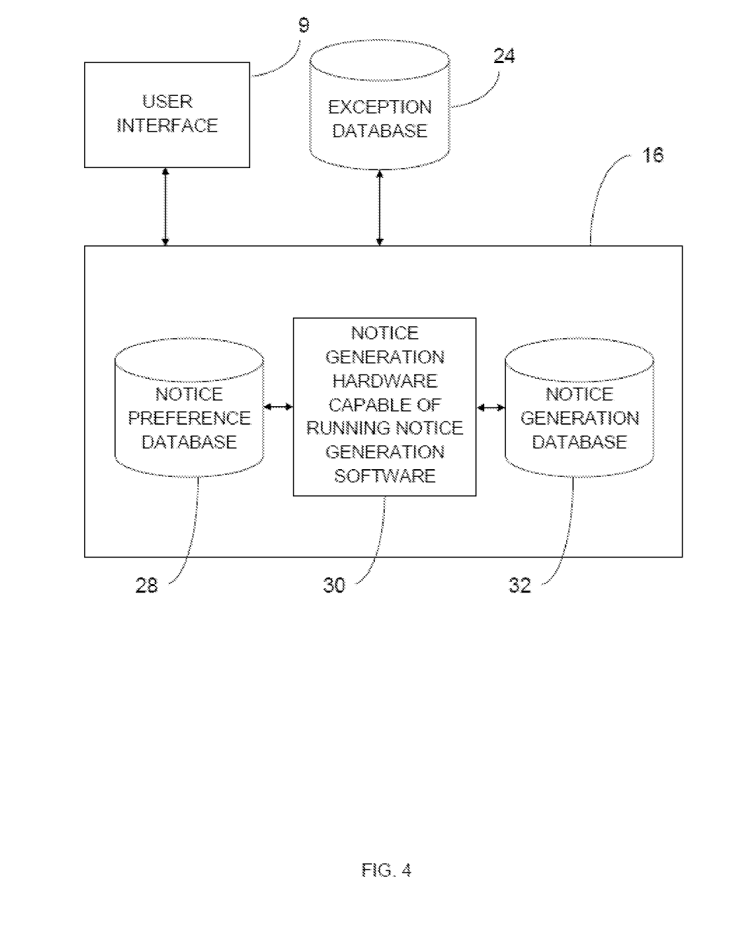

One or more exception databases 24 may be in communication with one or more notice generation systems 16. As described further with respect to FIG. 4 below, one or more notice generation systems 16 may be configured to receive, collect, store, and/or analyze exception data from one or more exception databases 24 continuously, at one or more random and/or pre-determined intervals, and/or on-demand (such as in response to one or more prompts from one or more users and/or systems, servers, components, interfaces, devices, etc.).

Referring specifically to FIG. 4, a detail view of a first particular implementation of a notice generation system is illustrated. The particular implementation of notice generation system 16 illustrated by FIG. 4 may include one or more notice preference databases 28. One or more notice preference databases 28 may include one or more “notice preferences” that may be set by one or more manufacturers and/or software providers (e.g. “default” preferences) and/or by one or more users (e.g. “user-defined” preferences), such as via one or more user interfaces. By way of non-limiting example, one or more “notice preferences” may include one or more preferences relating to, among other things, one or more notification levels at which one or more notice generation systems may generate one or more notices, one or more intervals at which one or more notice generation systems may communicate one or more notices, and/or any other user preference related to how, when, whether, and under what circumstances one or more notice generation systems generate and/or communicate one or more notices.

One or more notice generation systems 16 may further include notice generation hardware 30 capable of running notice generation software or “notice software” configurable to compare exception data (which may be received from one or more exception databases 24) to one or more notice preferences continuously, periodically and/or on-demand. The notice generation system 16 is further configurable to generate one or more notices when one or more notice preferences for communicating one or more notices has been met.

In some particular implementations, even if one or more exceptions are determined by one or more utility usage analysis systems 10 (FIG. 3), one or more notice generation systems 16 may not necessarily generate one or more notices for the one or more exceptions unless the one or more exceptions meets and/or exceeds one or more established notice preferences. In this way, minimal unexpected usage (as compared to historical usage data and/or other utility usage expectations, by way of non-limiting example) may not result in the automatic generation of one or more notices. Alternatively, in other particular implementations, one or more usage thresholds and/or one or more notice preferences may be set at equivalent levels such that when one or more exceptions of one or more given magnitudes are determined by one or more utility usage analysis systems 10, one or more notice generation systems 16 may automatically generate one or more notices.

It will be understood that one or more notices generated by one or more notice generation systems 16 may be communicated continuously, periodically and/or on-demand to one or more users, and/or others via one or more communications (such as one or more electronic mail messages, web-based reports, telephone calls, telephonic text messages, written notices, facsimile transmissions, and/or other communications) and/or stored in one or more notice generation databases 32. Depending upon the particular implementation, one or more generated notices may include, among other information, information relating to an amount and/or cost of a utility being used (or not being used), occupancy status of one or more residential units (whether occupied or unoccupied), one or more addresses for one or more residential units, one or more identities of one or more tenants, one or more comparisons of current usage to one or more expected and/or historical usages, one or more work-order authorizations, and/or any other information relating to one or more instances of unexpected utility usage, one or more exceptions, and/or one or more notices.

In some particular implementations, one or more portions of one or more comparisons at one or more utility usage analysis systems 10 may include differentiating between normal use conditions and use conditions indicative of unexpected utility usage (such as, by way of non-limiting example, unexpectedly high vacant unit utility usage). It will be understood that if unexpected utility usage is determined at one or more residential units, whether unoccupied or occupied, one or more notices may be generated. One or more notices may be communicated to one or more users (and/or systems, databases, servers, and/or components). In some particular implementations, one or more notices may be sent to one or more specific maintenance companies and/or personnel, so that maintenance personnel can be dispatched to attend to the unit or units in question. According to various particular implementations described herein, data and/or the results of various comparisons and/or analyses conducted at one or more utility usage analysis systems 10 may be transmitted to one or more notice generation systems 16 via one or more computer servers, satellites, internet connections, emails, telephone lines, and/or the like. In addition to the specific comparisons and analyses described herein, it will be appreciated that additional comparisons, analyses and/or monitoring may be accomplished with the various systems and methods disclosed herein.

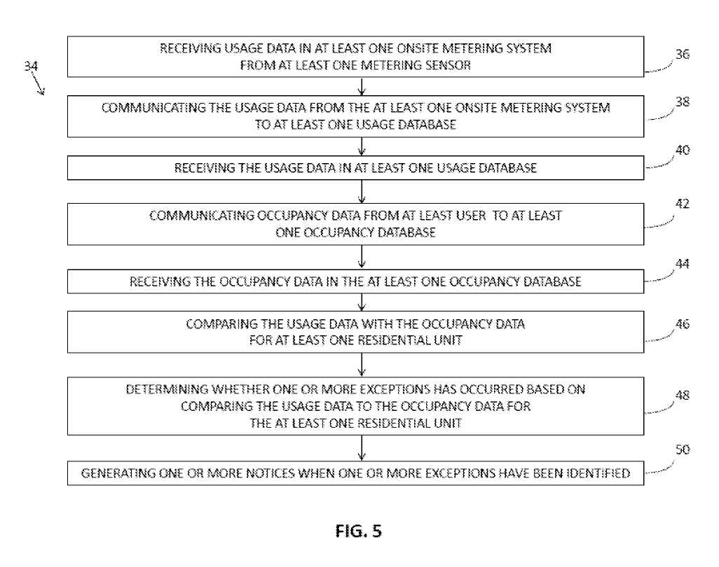

Turning now to FIG. 5, an exemplary hardware and software based method of identifying unexpected utility usage is illustrated. The method 34 begins at step 36, which includes receiving usage data in one or more onsite metering systems (such as onsite metering system 6) from one or more metering sensors (such as one or more metering sensors 18a-18n). The method further includes communicating the usage data from one or more onsite metering systems 6 to one or more usage databases 12 at step 38, and receiving the usage data in one or more usage databases at step 40.

At step 42, the method includes communicating occupancy data from one or more property management systems to one or more occupancy databases 14. Step 44 comprises receiving the occupancy data in one or more occupancy databases. The method at step 46 includes comparing usage data with occupancy data for one or more residential units. Step 48 further includes determining whether one or more exceptions has occurred based at least on comparing usage data to occupancy data for one or more residential units. Step 50 includes generating one or more notices via one or more notice generation systems when one or more exceptions have been identified.

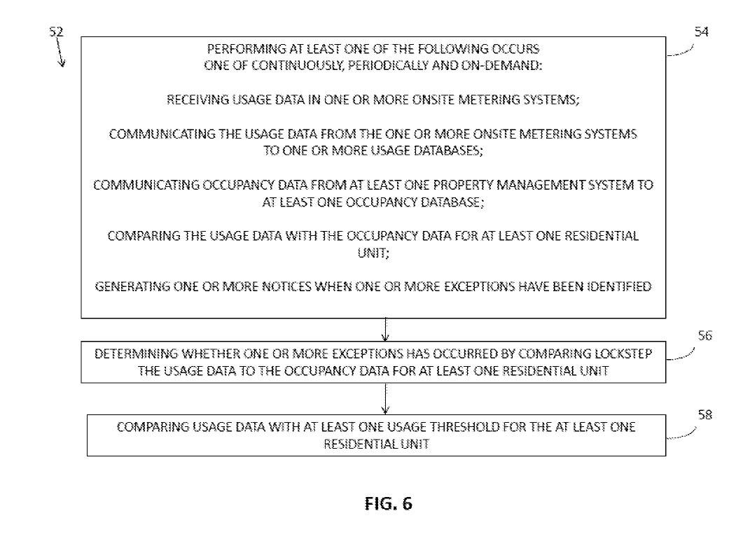

FIG. 6 illustrates an additional particular implementation of an exemplary method of operation 52 for identifying unexpected utility usage. The method may include step 54 which may include any or all of the following continuously, periodically and/or on-demand: receiving usage data in one or more onsite metering systems; communicating the usage data from the one or more onsite metering systems to one or more usage databases; communicating occupancy data from one or more property management systems to one or more occupancy databases; comparing the usage data with the occupancy data for one or more residential units; and/or generating one or more notices when one or more exceptions have been identified.

Step 56 may further comprise determining whether one or more exceptions has occurred by comparing lockstep the usage data to the occupancy data for at least one residential unit. Step 58 may include at least comparing usage data with at least one usage threshold for the at least one residential unit.

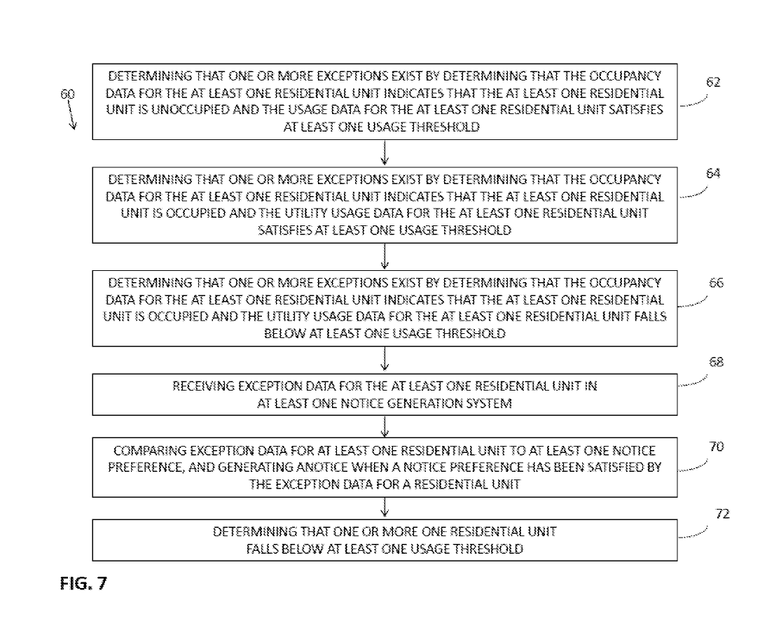

Turning now to FIG. 7, an additional particular implementation of an exemplary method of operation 60 for identifying unexpected utility usage is illustrated. At step 62, the method may include determining that one or more exceptions exist by determining that the occupancy data for the at least one residential unit indicates that the at least one residential unit is unoccupied and that the usage data for the at least one residential unit satisfies at least one usage threshold. Step 64 may comprise determining that one or more exceptions exist by determining that the occupancy data for the at least one residential unit indicates that the at least one residential unit is occupied and the utility usage data for the at least one residential unit satisfies at least one usage threshold. In addition, step 66 may include determining that one or more exceptions exist by determining that the occupancy data for the at least one residential unit indicates that the at least one residential unit is occupied and the utility usage data for the at least one residential unit falls below at least one usage threshold. At step 68, the method may include receiving exception data for the at least one residential unit in at least one notice generation system. Comparing the exception data for the at least one residential unit to at least one notice preference and generating at least one notice when at least one notice preference has been satisfied by the exception data for the at least one residential unit may occur at step 70. In addition, step 72 may include generating at least one notice when no exceptions have been determined (e.g. one or more “no unexpected utility usage determined” reports).

It will be understood that with respect to any of the methods disclosed herein, one or more steps may be performed in any order, without regard to order of operation. It will be further understood that additional method steps may be included according to the disclosures contained herein, as well as the needs of one or more particular users and/or applications.

In addition, depending upon the particular implementation being used, one or more queries may be performed on the various data, thresholds, preferences, comparisons, determinations, exceptions, notices, and/or other aspects disclosed herein. One or more queries may be initiated automatically and/or on-demand by one or more users and/or systems, servers, databases, software, etc. in order to search for obvious or even difficult-to-detect patterns of abnormalities. In some particular implementations, the usage analysis software may be further specifically configurable to identify at least the following utility events for one or more residential units such as, by way of non-limiting example, periodic irregular utility usage (e.g. one or more cycling toilets); constant utility usage (e.g. one or more broken lines, fixtures and/or appliances); and/or zero or near-zero usage (e.g. one or more possibly malfunctioning or by-passed meters and/or metering sensors).

The systems and methods of the present teachings may therefore provide a low-cost, automated system that can reliably detect unexpected utility usage in multiple unit residential facilities and notify users of such unexpected utility usage. The present teachings may therefore likewise provide an efficient and economical way of proactively monitoring and reporting unexpected utility usage, thereby assisting in preventing at least: unexpectedly high vacant unit utility usage; unexpectedly high occupied unit utility usage; and/or unexpectedly low occupied unit utility usage.

Those skilled in the art can appreciate from the foregoing descriptions that the present teachings can be implemented in a variety of forms and with tremendous flexibility. Therefore, while these teachings have been described in connection with particular embodiments and examples thereof, the true scope of the present teachings should not be so limited. Various changes and modifications may be made without departing from the scope of the teachings herein.

1. A utility management system associated with at least one multiple unit residential facility comprising:
at least one onsite metering system configured to monitor at least one metering sensor;
at least one property management system configured to communicate occupancy data for at least one residential unit;
at least one utility management server in communication with the at least one onsite metering system and the at least one property management system, the at least one utility management server comprising:
at least one usage database capable of receiving usage data from the at least one onsite metering system;
at least one occupancy database capable of receiving occupancy data from the at least one property management system;
at least one utility usage analysis system having usage analysis hardware capable of running usage analysis software configured to compare the usage data with the occupancy data for at least one residential unit to determine whether one or more exceptions exist; and
at least one notice generation system configured to receive exception data from the at least one utility usage analysis system, the at least one notice generation system having notice generation hardware capable of running notice generation software configured to generate at least one notice when one or more exceptions have been identified in the exception data.

2. The system of claim 1, wherein at least one of the following occurs one of continuously, periodically and on-demand:
the at least one onsite metering system is configured to monitor the at least one metering sensor;
the at least one property management system is configured to communicate occupancy data;
the at least one utility management server is capable of receiving the usage data from the at least one metering server and occupancy data from the at least one property management system;
the usage analysis software is configured to compare the usage data with the occupancy data; and
the notice generation software is configured to compare the exception data to one or more notice preferences

3. The system of claim 1, wherein at least one exception is determined based on a lockstep comparison of the usage data to the occupancy data for at least one residential unit.

4. The system of claim 1, wherein the at least one utility usage analysis system further comprises at least one usage threshold database capable of storing at least one default usage threshold.

5. The system of claim 1, wherein the usage threshold database is capable of receiving and storing at least one user-defined usage threshold communicated via at least one user interface.

6. The system of claim 1, wherein the usage analysis software is configured to determine that at least one exception exists when the occupancy data indicates that at least one residential unit is unoccupied and the usage data for the at least one residential unit one of meets and exceeds at least one usage threshold.

7. The system of claim 1, wherein the usage analysis software is configured to determine that at least one exceptions exist when the occupancy data indicates that at least one residential unit is occupied and the usage data for the at least one residential unit one of meets and exceeds at least one usage threshold.

8. The system of claim 1, wherein the usage analysis software is configured to determine that at least one exception exists when the occupancy data indicates that at least one residential unit is occupied and the usage data for the at least one residential unit one of meets and falls below at least one usage threshold.

9. The system of claim 1, wherein the utility usage analysis system further comprises at least one exception database configured to receive exception data from the usage analysis software.

10. The system of claim 1, wherein the at least one notice generation system is capable of receiving the exception data from the at least one exception database.

11. The system of claim 1, wherein the at least one notice generation system further comprises at least one notice preference database capable of storing at least one default notice preference.

12. The system of claim 1, wherein the notice preference database is capable of receiving and storing at least one user defined notice preference communicated via at least one user interface.

13. The system of claim 1, wherein the notice generation software is configured to compare the exception data to at least one notice preference and generate at least one notice when at least one notice preference has been satisfied by the exception data.

14. The system of claim 1, wherein the notice generation software is configured to generate at least one notice when no exceptions are identified in the exception data by the notice generation software.

15. A method of identifying unexpected usage of a utility comprising:
receiving usage data in at least one onsite metering system from at least one metering sensor;
communicating the usage data from the at least one onsite metering system to at least one usage database;
receiving the usage data in the at least one usage database;
communicating occupancy data from at least one property management system to at least one occupancy database;
receiving the occupancy data in the at least one occupancy database;
comparing the usage data with the occupancy data for at least one residential unit;
determining whether one or more exceptions has occurred based on comparing the usage data to the occupancy data for the at least one residential unit; and
generating one or more notices when one or more exceptions have been identified.

16. The method of claim 15, wherein at least one of the following occurs one of continuously, periodically and on-demand:
receiving usage data in at least one onsite metering system;
communicating the usage data from the at least one onsite metering system to at least one usage database;
communicating occupancy data from at least one property management system to at least one occupancy database;
comparing the usage data with the occupancy data for at least one residential unit;
determining whether one or more exceptions have occurred; and
generating one or more notices when one or more exceptions have been identified.

17. The method of claim 15, wherein determining whether one or more exceptions has occurred further comprises performing a lockstep comparison of the usage data to the occupancy data for at least one residential unit.

18. The method of claim 15, further comprising comparing usage data with at least one usage threshold for the at least one residential unit.

19. The method of claim 18, wherein determining that one or more exceptions exist comprises determining that the occupancy data for the at least one residential unit indicates that the at least one residential unit is unoccupied and the usage data for the at least one residential unit one of meets and exceeds the at least one usage threshold.

20. The method of claim 18, wherein determining that one or more exceptions exist comprises determining that the occupancy data for the at least one residential unit indicates that the at least one residential unit is occupied and the usage data for the at least one residential unit one of meets and exceeds the at least one usage threshold.

21. The method of claim 18, wherein determining that one or more exceptions exist comprises determining that the occupancy data for the at least one residential unit indicates that the at least one residential unit is occupied and the usage data for the at least one residential unit one of meets and falls below the at least one usage threshold.

22. The method of claim 15, further comprising receiving exception data for the at least one residential unit in at least one notice generation system.

23. The method of claim 15, further comprising comparing the exception data for the at least one residential unit to at least one notice preference and generating at least one notice when at least one notice preference has been satisfied by the exception data for the at least one residential unit.

24. The method of claim 15, further comprising generating at least one notice when no exceptions have been determined.
